(19) United States
(12) Patent Application Publication
(10) Pub. No.: US 2008/0014520 A1
(43) Pub. Date: Jan. 17, 2008

(54) Organic photoreceptor for short wavelengths and electrophotographic imaging forming apparatus employing the organic photoreceptor

(75) Inventors: Beom-jun Kim, Yongin-si (KR); Ji-young Lee, Suwon-si (KR); Saburo Yokota, Suwon-si (KR); Moto Makino, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/606,270

(22) Filed: Nov. 30, 2006

(30) Foreign Application Priority Data
Jul. 11, 2006 (KR) 10-2006-0064971

(51) Int. Cl. G03G 5/06

(52) U.S. Cl. 430/78; 399/159

(57) ABSTRACT

An organic photoreceptor and an electrophotographic image forming apparatus employing the organic photoreceptor are provided, where the organic photoreceptor has high photosensitivity with respect to light radiation at short wavelengths and low exposure potential. Specifically, an organic photoreceptor for short wavelengths having a photosensitive layer including a naphthalene tetracarboxylic acid diimide derivative is formed on an electrically conductive substrate.

### CROSS-REFERENCE TO RELATED PATENT APPLICATION

This application claims the benefit under 35 U.S.C. 119(a) of Korean Patent Application No. 10-2006-0064971, filed on Jul. 11, 2006 in the Korean Intellectual Property Office, the disclosure of which is hereby incorporated by reference in its entirety.

### BACKGROUND OF THE INVENTION

1. Field of the Invention

The present invention relates to an organic photoreceptor and an electrophotographic image forming apparatus employing the organic photoreceptor. More particularly, the invention relates to an organic photoreceptor for short wavelengths having high photosensitivity and low exposure potential with respect to optical radiation at short wavelengths. The invention further relates to an electrophotographic image forming apparatus employing the organic photoreceptor.

2. Description of the Related Art

Electrophotography is widely used in laser printers, copy machines, and the like. An organic photoreceptor in electrophotography includes a photosensitive layer formed on an electrically conductive. substrate and can be in the form of a plate, a disk, a sheet, a belt, or a drum, or the like. In the organic photoreceptor, a surface of the photosensitive layer is first uniformly and electrostatically charged, and then the charged surface is exposed to a pattern of light, thus forming an image. The light exposure selectively dissipates charges in the exposed regions of the surface irradiated by light, thereby forming a pattern of charged and uncharged regions, which is referred to as a latent image. Then, a wet or dry toner is provided in the vicinity of the latent image, and toner droplets or particles are deposited in either the charged or uncharged regions to form a toner image on the surface of the photosensitive layer. The resulting toner image can be transferred and fixed to a suitable final or intermediate receiving surface, such as paper, or the photosensitive layer can function as a final receptor for receiving the image.

Organic photoreceptors can be classified into two types. The first is a laminated type photoreceptor having a double-layer structure photosensitive layer that includes a charge-generating layer including a binder resin and a charge-generating material (CGM) and a charge-transporting layer including a binder resin and a charge-transporting material (CTM) (mainly, a hole-transporting material (HTM)). Laminated type photoreceptors are generally used in the fabrication of negative charge type organic photoreceptors. The other type of photoreceptor is a single-layered type photoreceptor in which a binder resin, a CGM, an HTM, and an electron-transporting material (ETM) are contained in a single layer. Single-layered type photoreceptors are generally used in the fabrication of positive charge type organic photoreceptors.

Positive charge type photoreceptors are advantageous for generating less ozone which is harmful to the human body and for their reduced manufacturing costs due to only having a single photosensitive layer. The main material that forms such single-layered positive charge type organic photoreceptors is an electron-transporting material. Electron-transporting materials that are currently used have 100 times smaller hole transporting capability than the hole transporting capability of hole transporting materials, and thus the performance of the single-layered type organic photoreceptors is determined by the electron-transporting capability of the electron-transporting material.

Meanwhile, as high-resolution printers are increasingly in demand, in order to obtain such high resolution, the spot size of the beams must be reduced during optical radiation, and a light source emitting light having a short wavelength as represented by the following equation is most effective.

<Equation>

d∝(π/4)(λf/D),

where d is the spot size, λ is the wavelength of laser light, f is the focal distance between lenses, and D is the diameter of the lenses.

Blue semiconductor laser diodes or light emitting diodes have been developed and used as light sources for emitting light having short wavelengths, and have an oscillation wavelength of 400 to 500 nm. Conventional electron-transporting materials are not suitable to be used for printers for short wavelengths in such a short wavelength range because of the high light absorption.

For example, compounds represented by Formulae i and ii below are known as conventionally used electron-transporting materials, and the light absorption thereof is illustrated in FIG. 1.

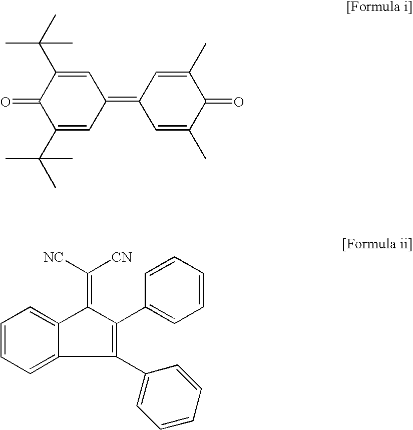

FIG. 1 is a graph illustrating the light absorption of the conventional electron-transporting materials (ETM) represented by Formulae i and ii. Referring to FIG. 1, relatively high light absorption is shown in the wavelength range of 400 to 500 nm, and thus the compounds represented by Formulae i and ii are not suitable for use as an electron-transporting material for high resolution printers using light at short wavelength.

Accordingly, a photoreceptor having high photosensitivity and low exposure potential is required to be developed by improving the light absorption at short wavelengths.

### SUMMARY OF THE INVENTION

The present invention provides an organic photoreceptor for short wavelengths to obtain high-resolution output.

The present invention also provides an electrophotographic image forming apparatus, an electrophotographic cartridge, and an electrophotographic drum employing the organic photoreceptor.

According to an aspect of the present invention, an organic photoreceptor for short wavelengths is provided, comprising: an electrically conductive substrate; and a photosensitive layer formed on the electrically conductive substrate, wherein the photosensitive layer comprises a naphthalene tetracarboxylic acid diimide derivative represented by Formula 1 below:

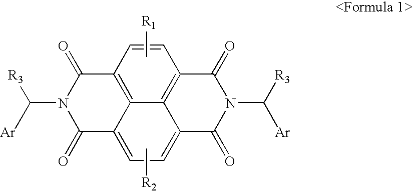

where R₁, and R₂ are each independently hydrogen, a halogen group, a C₁-C₂₀ substituted or unsubstituted alkyl group, or a C₁-C₂₀ substituted or unsubstituted alkoxy group;

R₃ is a C₁-C₂₀ substituted or unsubstituted alkyl group, a C₁-C₂₀ substituted or unsubstituted alkoxy group, a C₇-C₃₀ substituted or unsubstituted aralkyl group, or a —(CH₂)ₙ—Y—R₄ group, where Y is an oxygen atom or sulfur atom;

Ar is a C₆-C₃₀ substituted or unsubstituted aryl group;

R₄ is hydrogen atom, or a C₁-C₂₀ substituted or unsubstituted alkyl group; and

n is an integer from 1 to 12.

According to another aspect of the present invention, an electrophotographic image forming apparatus is provided comprising the organic photoreceptor for short wavelengths, comprising: an electrically conductive substrate; and a photosensitive layer formed on the electrically conductive substrate, wherein the photosensitive layer comprises a naphthalene tetracarboxylic acid diimide derivative represented by Formula 1.

According to another aspect of the present invention, an electrophotographic cartridge is provided comprising: an electrophotographic photoreceptor for short wavelengths, comprising: an electrically conductive substrate; and a photosensitive layer formed on the electrically conductive substrate, wherein the photosensitive layer comprises a naphthalene tetracarboxylic acid diimide derivative represented by Formula 1; and at least one selected from the group consisting of: a charging device for charging the electrophotographic photoreceptor; a developing device for developing an electrostatic latent image formed on the electrophotographic photoreceptor; and a cleaning device for cleaning a surface of the electrophotographic photoreceptor, the electrophotographic cartridge being attachable to or detachable from an imaging apparatus.

According to another aspect of the present invention, an electrophotographic drum is provided comprising: a drum attachable to and detachable from an image forming apparatus; and an organic photoreceptor for short wavelengths, comprising: an electrically conductive substrate; and a photosensitive layer formed on the electrically conductive substrate, wherein the photosensitive layer comprises a naphthalene tetracarboxylic acid diimide derivative represented by Formula 1.

According to another aspect of the present invention, an electrophotographic imaging forming apparatus is provided comprising: a photoreceptor unit comprising: an organic photoreceptor for short wavelengths, comprising: an electrically conductive substrate; and a photosensitive layer formed on the electrically conductive support, a charging device for charging the photoreceptor unit; an imagewise light-irradiating device for irradiating light onto the charged photoreceptor unit to form an electrostatic latent image on the photoreceptor unit; a developing unit for developing the electrostatic latent image with a toner to form a toner image on the photoreceptor unit; and a transfer device for transferring the toner image onto a receptor.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating the light absorption of a conventional electron-transporting material (ETM);

FIG. 2 is a schematic view of an image forming apparatus, an electrophotographic drum, and an electrophotographic cartridge, according to an embodiment of the present invention; and

FIG. 3 is a graph illustrating the light absorption of an ETM represented by Formulae 2 and 3.

### DETAILED DESCRIPTION OF THE INVENTION

The present invention will now be described more fully with reference to the accompanying drawings, in which exemplary embodiments of the invention are shown.

An organic photoreceptor according to an embodiment of the present invention can operate efficiently at short wavelengths by using electron-transporting materials (ETMs) represented by Formula 1 below, which rarely absorbs light at short wavelengths. Thus, the organic photoreceptor of the present embodiment has improved photosensitivity and improved electric properties due to reduced exposure potential, and thus, is useful for printers using lights of short wavelengths which can realize high resolution. In particular, a naphthalene tetracarboxylic acid diimide derivative in Formula 1 includes a branched alkyl group in which an aryl group is substituted at an a position based on nitrogen. Thus, the derivative of Formula 1 has better solubility to an organic solvent and higher compatibility with a polymeric binder resin than a conventional compound having a substituted alkyl group at the a position as in the prior compounds.

The organic photoreceptor according to the present embodiment includes a photosensitive layer formed on an electrically conductive substrate, and the photosensitive layer includes the naphthalene tetracarboxylic acid diimide derivative of Formula 1.

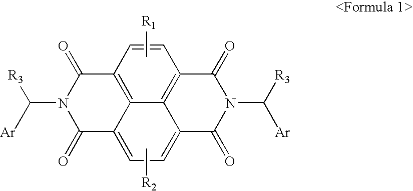

where R₁ and R₂ are each independently hydrogen, a halogen, a C₁-C₂₀ substituted or unsubstituted alkyl group, or a C₁-C₂₀ substituted or unsubstituted alkoxy group;

R₃ is a C₁-C₂₀ substituted or unsubstituted alkyl group, a C₁-C₂₀ substituted or unsubstituted alkoxy group, a C₇-C₃₀ substituted or unsubstituted aralkyl group, or a —(CH₂)ₙ—Y—R₄ group, where Y is an oxygen atom or a sulfur atom;

Ar is a C₆-C₃₀ substituted or unsubstituted aryl group;

R₄ is a hydrogen atom or a C₁-C₂₀ substituted or unsubstituted alkyl group; and

n is an integer from 1 to 12.

In the compound of Formula 1, R₁ and R₂ are preferably hydrogen and R₃ is preferably a methyl group, an ethyl group, a propyl group, a butyl group, a pentyl group, a benzyl group, or a methyl benzyl group, and Ar is preferably a phenyl group, a nitrophenyl group, a hydroxyl phenyl group, a halophenyl group, a methoxy phenyl group, a methyl phenyl group, a naphthyl group, an anthracenyl group, or a phenanthrenyl group.

The halogen group in Formula 1 is fluorine, chlorine, bromine, or iodine

The alkyl group is a C₁₋₂₀, preferably a C₁₋₁₂, linear or branched alkyl group. Examples of the alkyl group include methyl, ethyl, n-propyl, isopropyl, n-butyl, isobutyl, sec-butyl, tert-butyl, pentyl, hexyl, 1,2-dimethylpropyl, 2-ethylhexyl, and the like. At least one hydrogen atom in the alkyl group may be substituted with a halogen atom such as fluorine, chlorine, bromine or iodine.

The alkoxy group in Formula 1 is a C₁₋₂₀, preferably a C₁₋₂, linear or branched alkoxy group. Examples of the alkoxy group include methoxy, ethoxy, propoxy, and the like. At least one hydrogen atom in the alkoxy group may be substituted with a halogen atom such as fluorine, chlorine, bromine or iodine.

The aralkyl group is a C₇-C₃₀, preferably C₇-C₁₅, linear or branched aralkyl group. Examples of the aralkyl group include benzyl, methylbenzyl, phenylethyl, naphthylmethyl, naphthylethyl, and the like. At least one hydrogen atom in the aralkyl group may be substituted with a halogen atom such as fluorine, chlorine, bromine or iodine, an alkyl group, an alkoxy group, a nitro group, a hydroxy group, a sulfonic acid group, and the like.

R₃ of Formula 1 may be respectively a group represented as —(CH₂)ₙ—Y—R₄, where Y is an oxygen atom or a sulfur atom, n is an integer from 1 to 12, and R₄ is a hydrogen atom or a C₁-C₂₀ substituted or unsubstituted alkyl group. Examples of R₃ include hydroxyl methyl, hydroxyl ethyl, and —CH₂—S—CH₃.

The aryl group represented with Ar is a C₆-C₃₀ aromatic ring and includes a fused ring. Examples of the aryl group include phenyl, tolyl, xylyl, biphenyl, o-terphenyl, naphtyl, anthracenyl, phenanthrenyl, and the like. At least one hydrogen atom in the aryl group may be substituted with an alkyl group, an alkoxy group, a nitro group, a hydroxy group, a sulfonic acid group, or a halogen atom, and the like.

Preferable examples of the naphthalene tetracarboxylic acid diimide derivative of Formula 1 include the compounds represented by Formulae 2 through 19, but are not limited thereto.

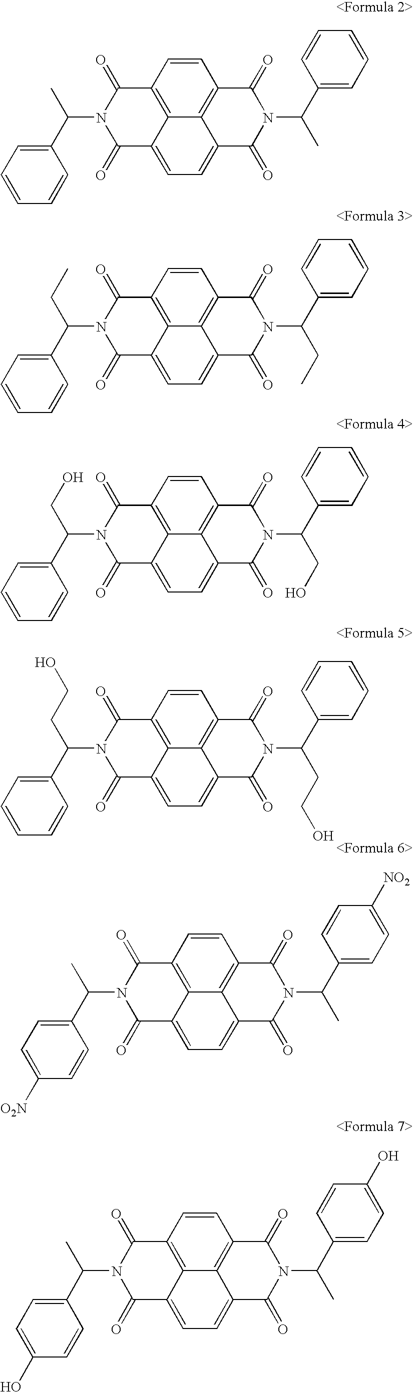

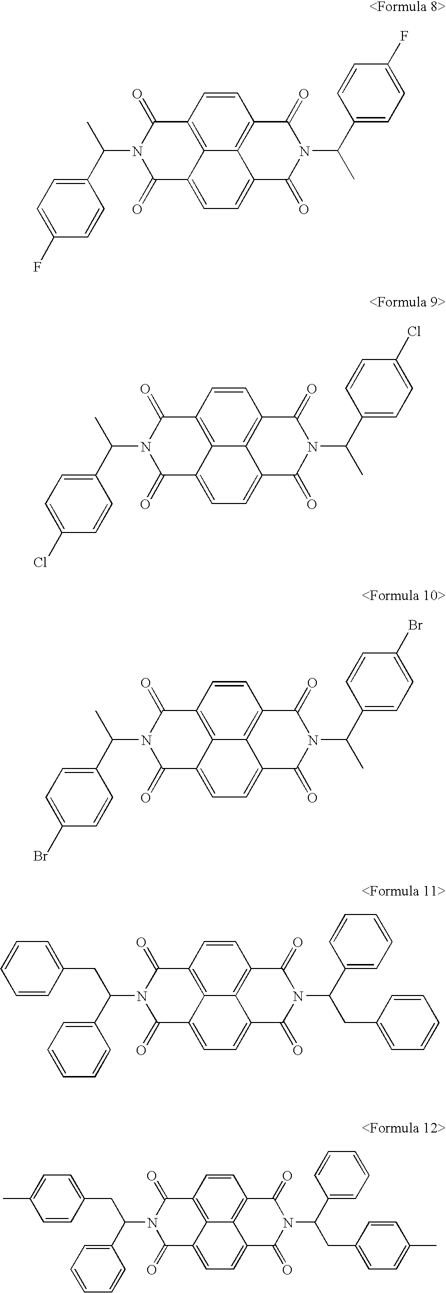

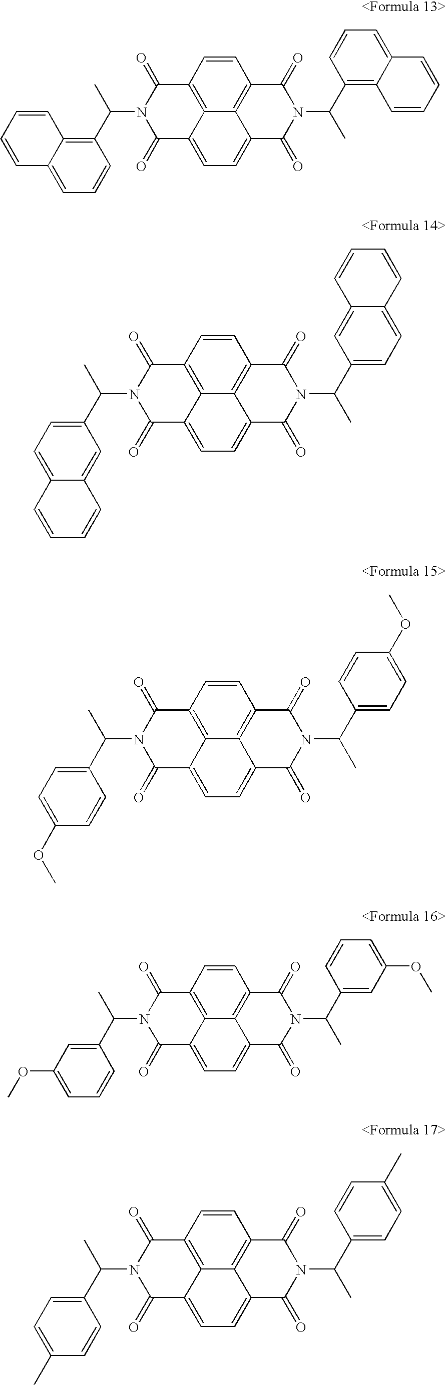

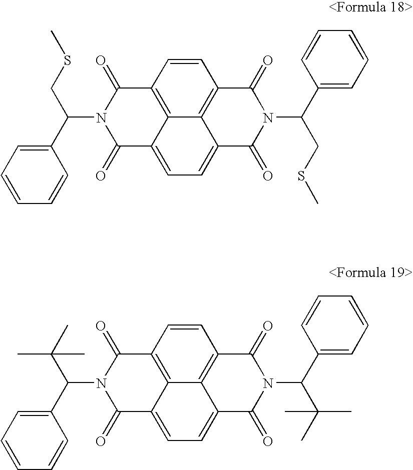

The naphthalene tetracarboxylic acid diimide derivative of Formula 1 in the present embodiment can be prepared by reacting with naphthalene tetracarboxylic acid anhydride of Formula 20 and secondary amine of Formula 21.

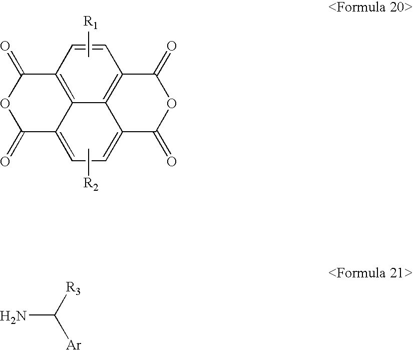

An organic solvent, for example, dimethyl formamide (DMF), dimethyl acetamide (DMAc), hexamethyl phosphoramide (HMPA), or N-methyl pyrrolidone (NMP) may be used for the reaction. The reaction temperature may be set in the range of 20° C. lower than a boiling point of the solvent up to the boiling point of the solvent, and preferably, in the range of 10° C. lower than the boiling point of the solvent up to the boiling point of the solvent.

Generally, the reaction may be carried out as follows. That is, naphthalene tetracarboxylic acid anhydride is dissolved in an organic solvent such as DMF, DMAc, HMPA, NMP, or other suitable solvent and then the secondary amine is added dropwise, and the temperature is raised to the melting point of the solvent and refluxed for 3 to 10 hours, thereby obtaining a naphthalene carboxylic diimide derivative. Here, a greater amount of secondary amine than a stoichiometrical amount may be used with respect to the naphthalene tetracarboxylic acid anhydride.

An electrophotographic image forming apparatus, an electrophotographic photoreceptor drum, and an electrophotographic cartridge employing the electrophotographic photoreceptor containing the naphthalene tetracarboxylic acid diimide derivative of Formula 1 will now be described in detail.

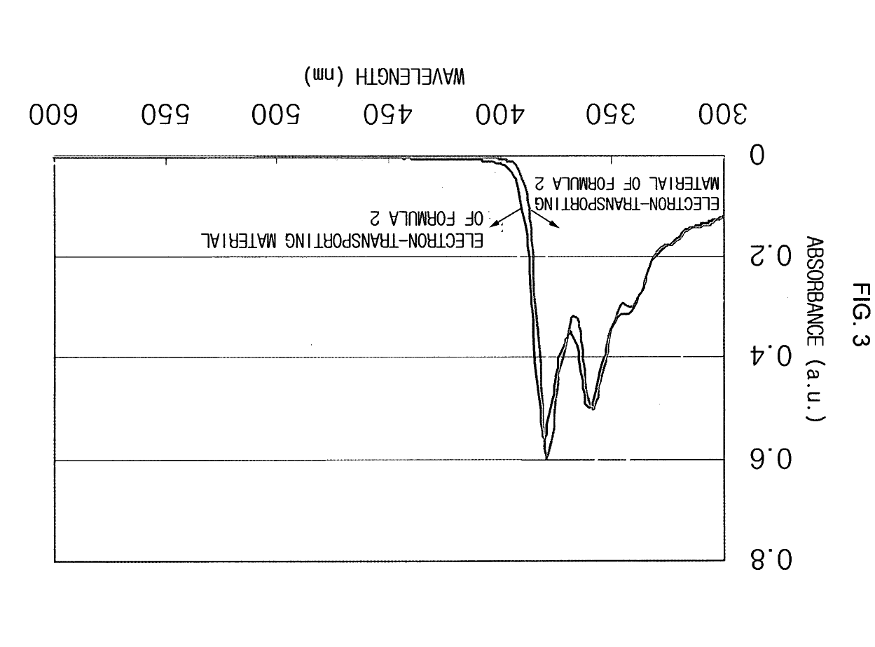

FIG. 2 schematically illustrates an image forming apparatus 30 including an electrophotographic photoreceptor drum 28 and an electrophotographic cartridge 21 according to an embodiment of the present invention. The electrophotographic cartridge 21 typically includes an electrophotographic photoreceptor 29, one or more charging devices 25 charging the electrophotographic photoreceptor 29, a developing device 24 developing an electrostatic latent image formed on the electrophotographic photoreceptor 29, and a cleaning device 26 cleaning a surface of the electrophotographic photoreceptor 29. The electrophotographic cartridge 21 can be attached to and detached from the image forming apparatus 30.

The electrophotographic photoreceptor drum 28 of the image forming apparatus 30 can generally be attached to and detached from the image forming apparatus 30.

Generally, the image forming apparatus 30 includes a photosensitive unit for example, the electrophotographic photoreceptor drum 28 and the electrophotographic photoreceptor 29; the charging device 25 for charging the photoreceptor unit; an imagewise light irradiating device 22 for irradiating light onto the charged photoreceptor unit to form an electrostatic latent image on the photoreceptor unit; the developing unit 24 for developing the electrostatic latent image with a toner to form a toner image on the photoreceptor unit; and a transfer device 27 for transferring the toner image onto a receiving material, such as paper P. The photoreceptor unit includes the electrophotographic photoreceptor 29, which will be described below. A voltage may be applied to the charging device 25 to charge the electrophotographic photoreceptor 29. The image forming apparatus 30 may also include a pre-exposure unit 23 to erase residual charge on the surface of the electrophotographic photoreceptor 29 to prepare for a next cycle.

The organic photoreceptor including the naphthalene tetracarboxylic acid diimide derivative of Formula 1 according to an embodiment of the present invention can be incorporated into electrophotographic imaging apparatuses, such as laser printers, photocopiers, and facsimile machines.

Hereinafter, an electrophotographic photoreceptor for short wavelengths containing the naphthalene tetracarboxylic acid diimide derivative of Formula 1 , which is employed in electrophotographic imaging apparatuses, according to an embodiment of the present invention, will be described in more detail.

The organic photoreceptor for short wavelengths of the present embodiment can be applied to laser light or a light emitting diode having an oscillation wavelength of 400 to 500 nm, thereby being advantageous for realizing high resolution. The organic photoreceptor for short wavelengths of the present embodiment include a photosensitive layer formed on an electrically conductive substrate. In one embodiment of the invention, the organic photoreceptor of the invention preferably exhibits a low absorbance at wavelengths of 400-500 nm. The organic photoreceptors of the invention typically have an absorbance of 0.2 (a.u.) in an oscillating wavelength of about 400-500 nm.

The electrically conductive substrate may be composed of metal, an electrically conductive polymer, or the like and may be in the form of a plate, a disk, a sheet, a belt, a drum, or other suitable structure. Examples of the metal include aluminum, stainless steel, and other suitable metals. Examples of the electrically conductive polymer include polyester resin, polycarbonate resin, polyamide resin, polyimide resin, mixtures thereof, and a copolymer thereof in which an electrically conductive material, such as electrically conductive carbon, tin oxide, indium oxide, and the like is dispersed.

The photosensitive layer may be a laminated type photosensitive layer in which a charge-generating layer and a charge-transporting layer are separately formed, or a single-layered type photosensitive layer in which a single layer acts as both a charge-generating layer and a charge-transporting layer.

The naphthalene tetracarboxylic acid diimide derivative of Formula 1 according to an embodiment of the present invention acts as a charge-transporting material, and preferably, an ETM. In a laminated type photosensitive layer, the naphthalene tetracarboxylic acid diimide derivative of Formula 1 is contained in the charge-transporting layer, and in a single-layered type photosensitive layer, the naphthalene tetracarboxylic acid diimide derivative of Formula 1 is naturally contained in a single layer together with a charge-generating material (CGM).

Examples of the CGM used in the photosensitive layer include organic materials such as phthalocyanine pigments, azo pigments, quinone pigments, perylene pigments, indigo pigments, bisbenzoimidazole pigments, quinacridone pigments, azulenium dyes, squarylium dyes, pyrylium dyes, triarylmethane dyes, and cyanine dyes, and inorganic materials such as amorphous silicon, amorphous selenium, trigonal selenium, tellurium, selenium-tellurium alloy, cadmium sulfide, antimony sulfide, and zinc sulfide. The CGM is not limited to the materials listed above, and may be used alone or in a combination of two or more.

In a laminated type photosensitive layer, the CGM is dispersed in a solvent with a binder resin and then the resulting solution is coated on the electrically conductive substrate using a dip coating method, a ring coating method, a roll coating method, or a spray coating method to form the charge-generating layer. The thickness of the charge-generating layer may be generally about 0.1-1 μm. When the thickness of the charge-generating layer is less than 0.1 μm, the photosensitivity is insufficient, and when the thickness of the charge-generating layer is greater than 1 μm, the charging ability and the photosensitivity are lowered.

A charge-transporting layer containing the naphthalene tetracarboxylic acid diimide derivative of Formula 1 is formed on the charge-generating layer of the laminated type photosensitive layer, but the charge-generating layer may be formed on the charge-transporting layer in reverse order. When forming the charge-transporting layer, the naphthalene tetracarboxylic acid diimide derivative of Formula 1 and the binder resin are dissolved in a solvent and the resulting solution is coated on the charge-generating layer. Examples of the coating method include a dip coating method, a ring coating method, a roll coating method, and a spray coating method, similar to the methods used to form the charge-generating layer. The thickness of the charge-transporting layer may be generally about 5-50 μm. When the thickness of the charge-transporting layer is less than 5 μm, the charging ability becomes poor, and when the thickness of the charge-transporting layer is greater than 50 μm, the response rate is reduced and the image quality is deteriorated.

When preparing a single-layered type photosensitive layer, the CGM is dispersed in a solvent together with the binder resin and the naphthalene tetracarboxylic acid diimide derivative of Formula 1 as the ETM and the resulting solution is coated on the electrically conductive substrate to obtain the photosensitive layer. The thickness of the photosensitive layer may be generally about 5-50 μm. The naphthalene tetracarboxylic acid diimide derivative of Formula 1 may be used together with other ETM and/or hole transporting material (HTM). In particular, in a single-layered type photoreceptor, it is preferable to use the naphthalene tetracarboxylic acid diimide derivative of Formula 1 together with a HTM.

Examples of the HTM that may be used with the naphthalene tetracarboxylic acid diimide derivative of Formula 1 in the single-layered type photosensitive layer include nitrogen containing cyclic compounds and condensed polycyclic compounds such as pyrene compounds, carbazole compounds, hydrazone compounds, oxazole compounds, oxadiazole compounds, pyrazoline compounds, arylamine compounds, arylmethane compounds, benzidine compounds, thiazole compounds and styryl compounds. Also, high molecular weight compounds having functional groups of the above compounds on a main chain or side chain may be used.

Examples of other ETM that may be used with the naphthalene tetracarboxylic acid diimide derivative of Formula 1 in the single-layered type photosensitive layer include, but are not limited to, electron attracting low-molecular weight compounds such as benzoquinone compounds, cyanoethylene compounds, cyanoquinodimethane compounds, fluorenone compounds, xanthone compounds, phenanthraquinone compounds, anhydrous phthalic acid compounds, thiopyrane compounds, and diphenoquinone compounds. Electron-transporting polymer compounds or pigments having n-type semiconductor characteristics may also be used.

The ETM or the HTM that may be used with the naphthalene tetracarboxylic acid diimide derivative of Formula 1 in the electrophotographic photoreceptor according to the current embodiment of the present invention are not limited to the materials listed above, and the foregoing materials may be used alone or in combination of two or more.

Examples of solvents used in preparing a coating composition for forming the photosensitive layer include organic solvents such as alcohols, ketones, amides, ethers, esters, sulfones, aromatics, halogenated aliphatic hydrocarbons, and other suitable solvents. The coating method of the coating composition may be a dip coating method, but a ring coating method, a roll coating method, a spray coating method, or the like may also be used.

Examples of the binder resin used in the formation of the photosensitive layer include, but are not limited to, polycarbonate, polyester, methacryl resin, acrylic resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenolic resin, polyamide, carboxy-methyl cellulose and polyurethane. These polymers may be used alone or in a combination of two or more.

The amount of the CTM including the ETM and the HTM in the photosensitive layer may be in the range of about 10-60% by weight based on the total weight of the photosensitive layer. If the amount of the CTM is less than 10% by weight, the photosensitivity is insufficient due to low charge-transporting ability, thereby resulting in an increased residual potential. If the amount of the CTM is greater than 60% by weight, the amount of the resin in the photosensitive layer is reduced, thereby reducing mechanical strength.

According to an embodiment of the present invention, an electroconductive layer may further be formed between the electrically conductive substrate and the photosensitive layer. The electroconductive layer is obtained by dispersing an electroconductive powder such as carbon black, graphite, metal powder or metal oxide powder in a solvent and then applying the resulting solution to the substrate and drying it. The thickness of the electroconductive layer may be about 5-50 μm.

Further, an intermediate layer may be interposed between the electrically conductive substrate and the photosensitive layer or between the electroconductive layer and the photosensitive layer to enhance adhesion or to prevent charges from being injected from the electrically conductive substrate. Examples of the intermediate layer include, but are not limited to, an aluminum anodized layer; a resin-dispersed layer in which metal oxide powder such as titanium oxide or tin oxide is dispersed; and a resin layer such as polyvinyl alcohol, casein, ethylcellulose, gelatin, phenol resin, or polyamide. The thickness of the intermediate layer may be about 0.05-5 μm.

Also, each of the photosensitive layer, the electroconductive layer, and the intermediate layer may further comprise at least one additive selected from a dispersion stabilizing agent, a plasticizer, a leveling agent, an antioxidant, and an optical stabilizer, in addition to the binder resin. The amount of the additive may be about 0.01 through 20% by weight with respect to the total weight amount of the photosensitive layer.

Examples of the plasticizer include biphenyl, chlorinated biphenyl, terphenyl, dibutyl phthalate, diethylene glycol phthalate, dioctyl phthalate, triphenyl phosphite, methylnaphthalene, benzophenone, chlorinated paraffin, polypropylene, polystyrene, various fluorinated hydrocarbons, other suitable plasticizers, but are not limited thereto.

Examples of the leveling agent include silicone oil, fluorine resin, and the like.

Examples of the antioxidant include phenol-based, sulfur-based, phosphor-based, and amine-based compounds. Examples of the phenol-based compound include 2,6-di-tert-butyl phenol, 2,6-di-tert-butyl-4-methoxyphenol, 2,6-di-tert-butyl-4-methylphenol, 2-tert-butyl-4-methoxyphenol, 2,4-di-methyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methylphenol, 2,4,6-tert-butylphenol, 2,6-di-tert-butyl-4-stearylpropionate phenol, α-tocopherol, β-tocopherol, γ-tocopherol, naphtolAS, naphtolAS-D, naphtol AS-BO, 4,4′-methylene bis(2,6-di-tert-butylphenol), 4,4′-methylene bis(6-tert-butyl-4-methylphenol), 2,2′-methylene bis(4-methyl-6-tert-butylphenol), 2,2′-methylene bis(4-ethyl-6-tert-butylphenol), 2,2′-ethylene bis(4,6-di-tert-butylphenol), 2,2′-propylene bis(4,6-di-tert-butylphenol), 2,2′-butane bis(4,6-di-tert-butylphenol), 2,2′-ethylene bis(6-tert-butyl-m-cresol), 4,4′-butane bis(6-tert-butyl-m-cresol), 2,2′-butane bis((6-tert-butyl-p-cresol), 2,2′-thiobis((6-tert-butylphenol), 4,4′-thiobis(6-tert-butyl-m-cresol), 4,4′-thiobis(6tert-o-cresol), 2,2thiobis( 4-methyl-6-butylphenol),1,3,5-trimethyl-2,4,6-tris(3,5-di-tert-butyl-4-hydroxybenzyl)benzene, 1,3,5-trimethyl-2,4,6-tris(3,5-di-tert-amil-4-hydroxybenzyl)benzene, 1,3,5-trimethyl-2,4,6-tris(3-tert-butyl-5-methyl-4-hydroxybenzyl)benzene, 2-tert-butyl-5-methyl-phenylaminephenol, 4,4′bisamino(2-tert-butyl-4-methylphenol), N-octadesil-3-(3′,5′-di-tert-butyl-4′-hydroxyphenyl)propionate 2,2,4-trimethyl-6-hydroxy-7-tert-butyl chroman, tetrakis(methylene-3(3,5-di-tert-butyl-4-hydroxyphenyl)propionate)methane, and 1,1,3-tris(2-methyl-4-hydroxy-5-tert-butylphenyl)butane, but are not limited thereto.

Examples of the optical stabilizer include benzotriazole-based compound, benzophenone-based compounds, and hindered amine compound.

Also, when necessary, the organic photoreceptor according to an embodiment of the present invention may further include an intermediate layer or a surface protecting layer.

Hereinafter, preferable examples of the present invention will be described, however, these examples are for illustrative purposes only and are not intended to limit the scope of the present invention.

### MANUFACTURING EXAMPLE 1

### Synthesis of the Compound of Formula 2

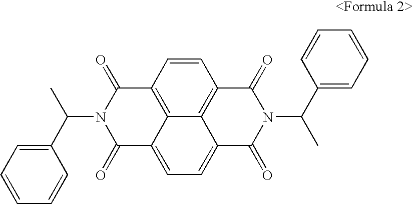

A 250 ml three neck flask equipped with a reflux condenser was purged with nitrogen, and then 10.72 g (0.04 mol) of 1,4,5,8-naphthalene tetracarboxylic acid anhydride and 100 ml of DMF were poured into the flask and stirred. Then a solution obtained by solving 9.7 g (0.08 mol) of a-methylbenzylamine in 20 ml of DMF was added dropwise, and the reaction compound was stirred in the reaction mixture. The solution was warmed to 153° C. through 154° C. and then refluxed for 3 hours, and then cooled again to ambient temperature. 60 ml of methanol was added to the reaction mixture and then precipitated to obtain a solid. The resultant solid was recrystallized from a chloroform/methanol solvent and dried in a vacuum to obtain 15.37 g of the compound of Formula 2 as a white crystal (yield 81%).

### MANUFACTURING EXAMPLE 2

### Synthesis of the Compound of Formula 3

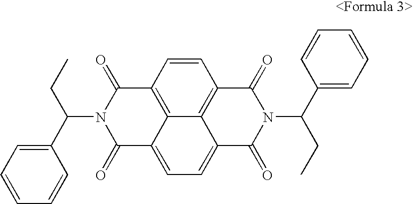

The same process as in Synthesis Example 1 was used, except that 10.82 g (0.08 mol) of 1-phenylpropylamine was used instead of α-methylbenzylamine to obtain 15.86 g of the compound of Formula 3 (yield 79%) as a white crystal.

### EXPERIMENTAL EXAMPLE 1

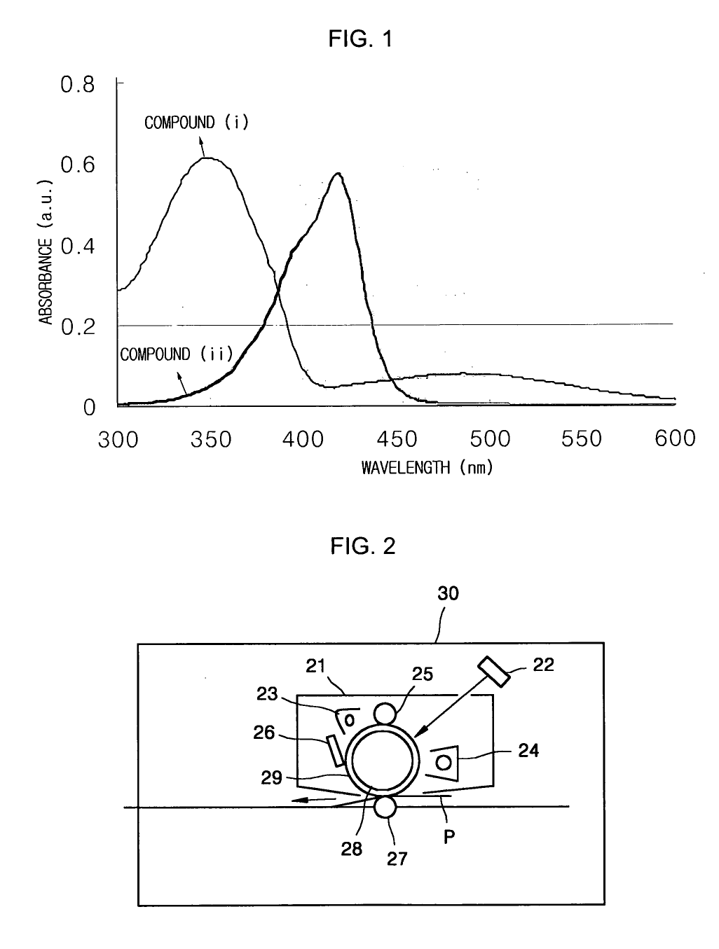

The light absorption of the ETM of Formulae 2 and 3 obtained in Manufacturing Examples 1 and 2 was measured and is illustrated in FIG. 3. As is evident from FIG. 3, the light absorption of the ETM in the present embodiment is lower than the conventional ETM in the range of 400 through 500 nm, compared to FIG. 1.

### EXAMPLE 1

26 parts by weight of the ETM obtained in Manufacturing Example 1, 3 parts by weight of the CGM of Formula 41 below (y-TiOPc, titanyloxy phthalocyanine), 26 parts by weight of the HTM of Formula 42 below, 45 parts by weight of the binder resin of Formula 43 below, 420 parts by weight of methylene chloride, and 105 parts by weight of 1,1,2-trichloroethane were sand milled for 2 hours and uniformly dispersed using ultrasonic waves. The obtained solution was coated on an anodized aluminum drum using a ring method and dried at 110° C. for 1 hour to prepare a single layered organophotoreceptor aving a thickness of about 15-16 μm.

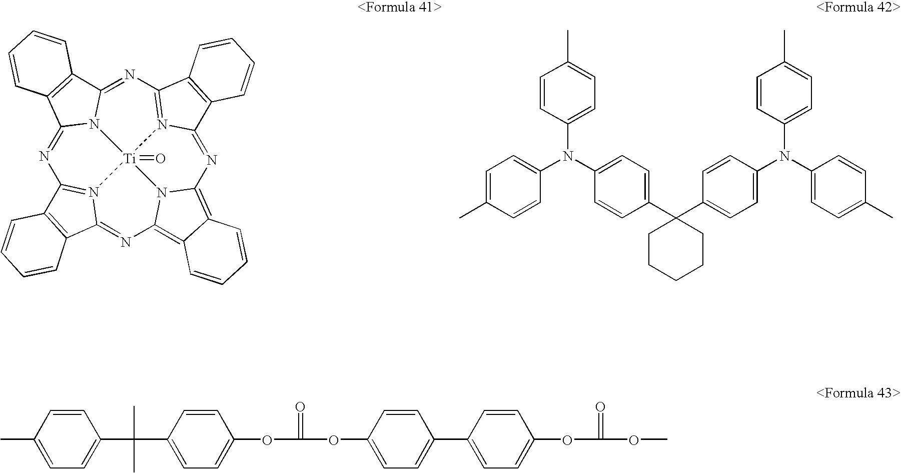

where x is 0.15 and y is 0.85.

### EXAMPLE 2

An organic photoreceptor was manufactured in the same manner as in Example 1, except that the ETM of Formula 3 obtained in Manufacturing Example 2 was used instead of the ETM of Formula 2.

### EXAMPLE 3

An organic photoreceptor was manufactured in the same manner as in Example 1, except that the HTM of Formula 44 was used instead of the HTM of Formula 42.

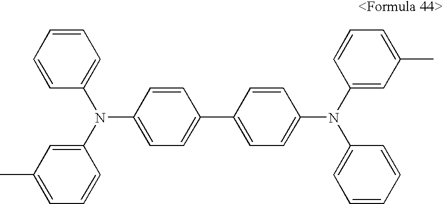

### EXAMPLE 4

An organic photoreceptor was manufactured in the same manner as in Example 1, except that the ETM of Formula 3 obtained in Manufacturing Example 2 was used instead of the ETM of Formula 2 and that the HTM of Formula 44 was used instead of the HTM of Formula 42.

### COMPARATIVE EXAMPLE 1

An organic photoreceptor was manufactured in the same manner as in Example 1, except that an ETM of Formula i was used instead of the ETM of Formula 2.

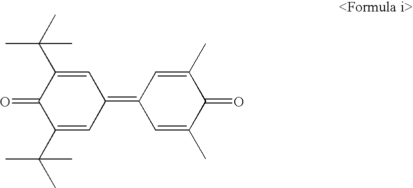

### COMPARATIVE EXAMPLE 1

An organic photoreceptor was manufactured in the same manner as in Example 1, that an ETM of Formula ii was used instead of the ETM of Formula 2.

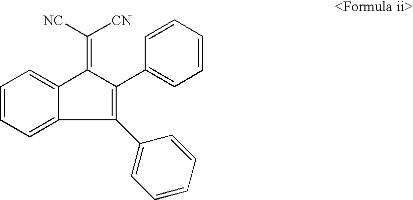

Electrophotographic properties of the respective organic photoreceptor prepared in Examples 1 through 4 and Comparative Examples 1 and 2 were measured using a drum photoreceptor evaluation apparatus (Cynthia_{—}92KSS). The evaluation conditions were as follows: an LED having a wavelength of 430 nm was used as a light source; a charge potential Vₒ was 600 V; the surface potential was recorded after exposure; and the relationship between the energy and the surface potential was measured. The results are shown in Table 1.

TABLE 1

| | E_{1/2} | E₂₀₀ | E₁₀₀ |
|---|---|---|---|
| Example 1 | 0.43 | 0.85 | 1.49 |
| Example 2 | 0.44 | 0.87 | 1.55 |
| Example 3 | 0.57 | 1.15 | 2.65 |
| Example 4 | 0.56 | 1.09 | 2.45 |
| Comparative | 1.98 | 3.54 | — |
| Example 1 | | | |
| Comparative | 1.32 | 2.65 | — |
| Example 2 | | | |

E_{1/2}: photosensitivity, optical energy required for the surface potential to be half
E₂₀₀(μJ/cm²): optical energy required for the surface potential to be 200 V
E₁₀₀(μJ/cm²): optical energy required for the surface potential to be 100 V

As is evident from Table 1, Examples 1 through 4 have lower E_{1/2}, E₁₀₀, and E₂₀₀ than Comparative Examples 1 and 2. This is because light at 430 nm easily reaches the CGM due to low light absorption of ETM of Formulae 2 and 3 and thus efficiently generates charges in Examples 1 through 4, and thus the photosensitivity is high and E₁₀₀ and E₂₀₀ are low. In the case of Comparative Examples 1 and 2, the light absorption of the compound of Formulae i and ii is high. Thus most of the light at 430 nm is absorbed, and thus the light cannot arrive at the CGM and cannot efficiently generate charges, thereby having poor electric properties.

As is evident from the results above, the organic photoreceptor according to the present invention is appropriate for light at short wavelengths in the range of 400 through 500 nm, and thus is useful for high-resolution printers, and the like. The organic receptor of Formula 1 typically exhibits an absorbance at wavelength in the range of 400-500 nm of 0.2 (a.u.) or less.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic photoreceptor for short wavelengths, comprising:
an electrically conductive substrate; and
a photosensitive layer formed on the electrically conductive substrate, wherein the photosensitive layer comprises a naphthalene tetracarboxylic acid diimide derivative represented by Formula 1 below: 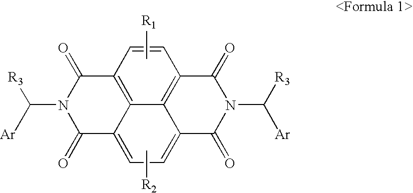
where R₁, and R₂ are each independently hydrogen, a halogen group, a C₁-C₂₀ substituted or unsubstituted alkyl group, or a C₁-C₂₀ substituted or unsubstituted alkoxy group;
R₃ is a C₁-C₂₀ substituted or unsubstituted alkyl group, a C₁-C₂₀ substituted or unsubstituted alkoxy group, a C₇-C₃₀ substituted or unsubstituted aralkyl group, or a —(CH₂)ₙ—Y—R₄ group, where Y is an oxygen atom or a sulfur atom;
Ar is a C₆-C₃₀ substituted or unsubstituted aryl group;
R₄ is hydrogen atom, or a C₁-C₂₀ substituted or unsubstituted alkyl group; and
n is an integer from 1 to 12.

2. The organic photoreceptor of claim 1, wherein R₁ and R₂ are hydrogen, and R₃ is a methyl group, an ethyl group, a propyl group, a butyl group, a pentyl group, a benzyl group or a methylbenzyl group, Ar is phenyl, a nitrophenyl group, a hydroxyphenyl group, a halophenyl group, a methoxyphenyl group, a methylphenyl group, an naphthal group, an anthracenyl group, or a phenanthrenyl group.

3. The organic photoreceptor of claim 1, wherein R₁ and R₂ are hydrogen.

4. The organic photoreceptor of claim 3, wherein R₃ is an alkyl group, hydroxyalkyl group, or phenyl group.

5. The organic photoreceptor of claim 4, wherein Ar is selected from the group cosisting of phenyl, nitrophenyl, hydroxyphenyl, halophenyl, benzyl, methylbenzyl, naphthyl, methoxyphenyl, and methylphenyl.

6. The organic photoreceptor of claim 1, wherein the naphthalene tetracarboxylic diimide derivative of Formula 1 is at least one selected from the group consisting of the compounds represented by Formulae 2 through 19 below:

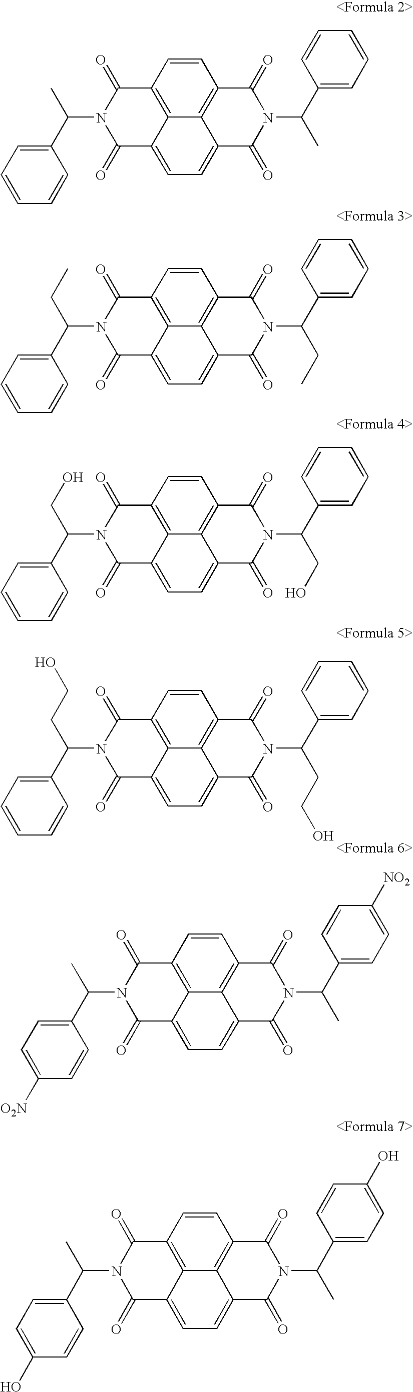

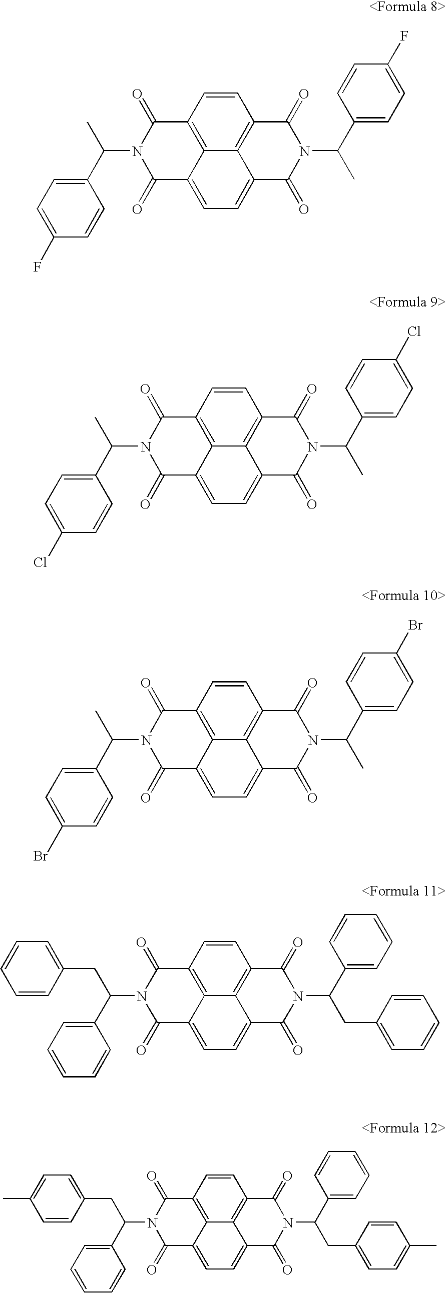

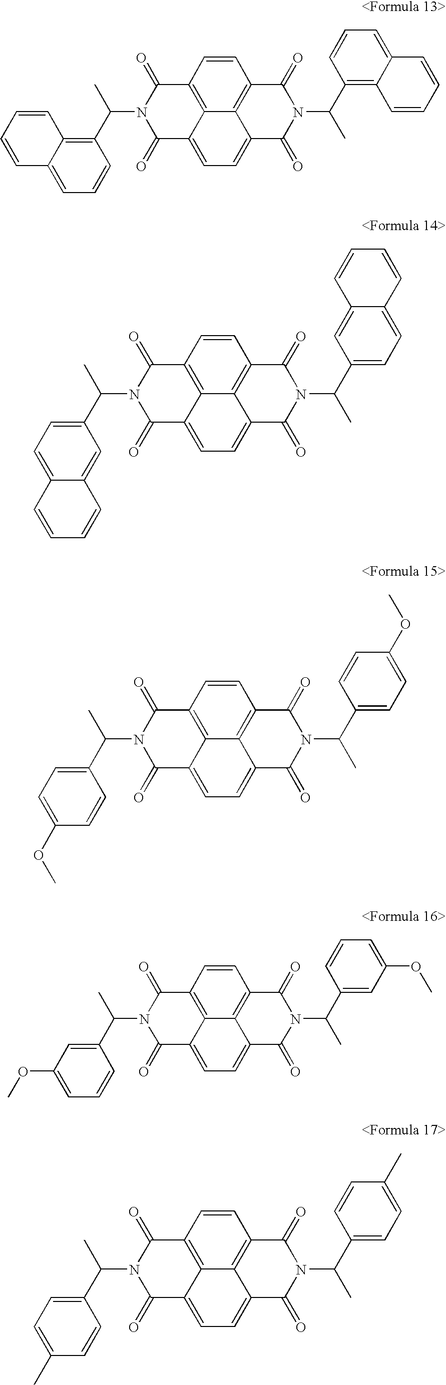

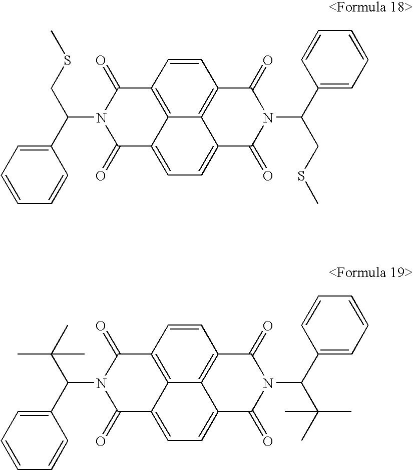

7. The organic photoreceptor of claim 1, wherein the photosensitive layer is a multi-layered type photosensitive layer.

8. The organic photoreceptor of claim 1, wherein the photosensitive layer is a multi-layered type photosensitive layer.

9. The organic photoreceptor of claim 1, wherein the short wavelengths are in the range of about 400 to 500 nm.

10. An electrophotographic image forming apparatus comprising an organic photoreceptor of claim 1.

11. An electrophotographic cartridge comprising:
an electrophotographic photoreceptor according to claim 1; and
at least one selected from the group consisting of:
a charging device to charge the electrophotographic photoreceptor;
a developing device to develop an electrostatic latent image formed on the electrophotographic photoreceptor; and
a cleaning device to clean a surface of the electrophotographic photoreceptor,
the electrophotographic cartridge being attachable to or detachable from an imaging apparatus.

12. An electrophotographic drum comprising:
a drum attachable to and detachable from an image forming apparatus; and
an organic photoreceptor for short wavelengths of claim 1.

13. An electrophotographic imaging forming. apparatus comprising:
a photoreceptor unit comprising:
an organic photoreceptor for short wavelengths comprising:
an electrically conductive substrate; and
a photosensitive layer formed on the electrically conductive support,
wherein the photosensitive layer comprises at least one compound of claim 1,
a charging device to charge the photoreceptor unit;
an imagewise light-irradiating device to irradiate light onto the charged photoreceptor unit to form an electrostatic latent image on the photoreceptor unit;
a developing unit to develop the electrostatic latent image with a toner to form a toner image on the photoreceptor unit; and
a transfer device to transfer the toner image onto a receptor.
